(19) United States
(12) Patent Application Publication
(10) Pub. No.: US 2019/0373103 A1
(43) Pub. Date: Dec. 5, 2019

(54) PORTABLE INFORMATION TERMINAL, METHOD FOR CONTROLLING, AND PROGRAM

(71) Applicant: NEC CORPORATION, Tokyo (JP)

(72) Inventor: Toshiyuki OGA, Tokyo (JP)

(73) Assignee: NEC CORPORATION, Tokyo (JP)

(21) Appl. No.: 16/478,681

(22) PCT Filed: Nov. 17, 2017
(86) PCT No.: PCT/JP2017/041545

§ 371 Date: Jul. 17, 2019

(30) Foreign Application Priority Data
Jan. 18, 2017 (JP) 2017-006804

(51) Int. Cl. H04M 1/725

(52) U.S. Cl. CPC H04M 1/72569; H04M 2250/52; H04M 1/72577

(57) ABSTRACT

A portable information terminal includes: a configuration as a smartphone that is used at the time of using a function as a smartphone and associated with a predetermined face of a case of the portable information terminal; a configuration as a transceiver that is used at the time of using a function as a transceiver and associated with a face located on an opposite side of the case from the face associated with the configuration as the smartphone; a posture information acquisition part configured to acquire posture information showing a posture of the portable information terminal; and a function control part configured to control the function as the smartphone and the function as the transceiver based on the posture information acquired by the posture information acquisition part.

### TECHNICAL FIELD

The present invention relates to a portable information terminal, a method for controlling a portable information terminal, and a program. More specifically, the present invention relates to a portable information terminal which has a function as a transceiver and also has a function as a smartphone, a method for controlling the portable information terminal, and a program.

### BACKGROUND ART

A portable information terminal which has a function as a transceiver is known.

For example, Patent Document 1 describes a portable information terminal (a mobile phone device) which incorporates a transceiver-type communication means. To be specific, the portable information terminal, inside a service area provided by a telecommunications carrier, selects mobile phone communication as a communication method and activates a mobile phone communication circuit. On the other hand, the portable information terminal, outside the service area provided by the telecommunications carrier, selects transceiver-type communication as a communication method and activates a transceiver-type communication circuit. According to Patent Document 1, the configuration described above enables communication between devices outside a service area and can increase the convenience of a portable information terminal.

Patent Document 1: Japanese Unexamined Patent Application Publication No. JP-A 11-088959 (1999)

For example, in the field of public safety such as police and fire fighting, a push-to-talk (PTT) transceiver is used in general. PTT is a method in which voice communication is simplex, that is, transmission and reception are exclusively performed. A PTT transceiver is provided with a large-diameter speaker on its surface, and therefore, is suitable for use where a plurality of users simultaneously share voice information being produced. Moreover, a PTT transceiver can be simplified in structure and function, and therefore, can suppress power consumption. Thus, a PTT transceiver has advantages. Therefore, it is thought that the PTT transceiver will continue to be in demand in the field of public safety, and so on.

On the other hand, use of an image terminal such as a smartphone and a tablet terminal, in which image information communication is mainly performed, has been widespread. It is also thought that such an image terminal will be in demand in more scenes from the viewpoint of convenience, and so on.

From the above, while a PTT transceiver has advantages, it is expected that an image terminal will also be in demand in more scenes. Therefore, it is thought to be desirable to realize a portable information terminal which has a function realized by a PTT transceiver and a function of an image terminal such as a smartphone.

It is assumed that the portable information terminal as described above performs PTT communication also within a service area of a telecommunications carrier. Therefore, according to the technique as described in Patent Document 1, it is difficult to perform PTT communication within a service area of a telecommunications carrier, so that it is difficult to meet the demand as described above.

In order to solve the above problem, it is only necessary to enable PTT communication also within a service area of a telecommunications carrier. However, if simply PTT communication is enabled also within a service area of a telecommunications carrier, dual functions are executed, which will cause other problems such as increase of power consumption and, in a case where a plurality of wireless systems simultaneously operate, higher possibility of occurrence of radio wave interference. Alternatively, it can also be thought to selectively use the transceiver function and the smartphone function. However, when selectively using the function, it is required to issue an instruction to start or stop the function and an instruction to switch or select the function, and there is a risk that the operability of the portable information terminal deteriorates.

Thus, there has been a problem that, regarding a portable information terminal also having a function as a transceiver, there is a risk of increase of power consumption, occurrence of radio wave interference, and deterioration of operability.

### SUMMARY

Accordingly, an object of the present invention is to provide a portable information terminal which solves the problem that, regarding a portable information terminal also having a function as a transceiver, there is a risk of increase of power consumption, occurrence of radio wave interference and deterioration of operability, a method for controlling the portable information terminal, and a program.

In order to achieve the object, a portable information terminal as an aspect of the present invention includes: a configuration as a smartphone that is used at a time of using a function as a smartphone and associated with a predetermined face of a case of the portable information terminal; a configuration as a transceiver that is used at a time of using a function as a transceiver and associated with a face located on an opposite side of the case from the face associated with the configuration as the smartphone; a posture information acquisition part configured to acquire posture information showing a posture of the portable information terminal; and a function control part configured to control the function as the smartphone and the function as the transceiver based on the posture information acquired by the posture information acquisition part.

Further, a portable information terminal controlling method as another aspect of the present invention is a portable information terminal controlling method executed by a portable information terminal which includes a configuration as a smartphone that is used at a time of using a function as a smartphone and associated with a predetermined face of a case of the portable information terminal, and a configuration as a transceiver that is used at a time of using a function as a transceiver and associated with a face located on an opposite side of the case from the face associated with the configuration as the smartphone. The portable information terminal controlling method includes: acquiring posture information showing a posture of the portable information terminal; and controlling the function as the smartphone and the function as the transceiver based on the acquired posture information.

Further, a computer program as another aspect of the present invention is a computer program including instructions for causing a portable information terminal to perform operations. The portable information terminal includes a configuration as a smartphone that is used at a time of using a function as a smartphone and associated with a predetermined face of a case of the portable information terminal, and a configuration as a transceiver that is used at a time of using a function as a transceiver and associated with a face located on an opposite side of the case from the face associated with the configuration as the smartphone. The operations include: acquiring posture information showing a posture of the portable information terminal; and controlling the function as the smartphone and the function as the transceiver based on the acquired posture information.

With the configurations described above, the present invention can provide a portable information terminal which solves the problem that, regarding a portable information terminal also having a function as a transceiver, there is a risk of increase of power consumption, occurrence of radio wave interference and deterioration of operability, a method for controlling the portable information terminal, and a program.

### BRIEF DESCRIPTION OF DRAWINGS

FIG. 1 is a front view showing an example of a portable information terminal according to a first example embodiment of the present invention;

FIG. 2 is a back view showing an example of the portable information terminal according to the first example embodiment of the present invention;

FIG. 3 is a block diagram showing an example of the configuration of the portable information terminal shown in FIGS. 1 and 2;

FIG. 4 is a function block diagram showing an example of a function realized by a processor shown in FIG. 3;

FIG. 5 is a view showing an example of a state in which the user holds the portable information terminal with the front side up;

FIG. 6 is a view showing an example of a state in which the user holds the portable information terminal with the back side up;

FIG. 7 is a view showing an example of a state in which the user vertically holds the portable information terminal held with the front side up;

FIG. 8 is a view showing an example of a state in which the user vertically holds the portable information terminal held with the back side up;

FIG. 9 is a flowchart showing an example of a flow when the portable information terminal according to the first example embodiment of the present invention controls a function;

FIG. 10 is a flowchart showing an example of a flow when the portable information terminal according to the first example embodiment of the present invention controls a function;

FIG. 11 is a view for describing an example when the portable information terminal acquires posture information based on image information;

FIG. 12 is a view for describing an example when the portable information terminal acquires posture information based on image information;

FIG. 13 is a view for describing an example when the portable information terminal acquires posture information based on image information;

FIG. 14 is a view for describing an example when the portable information terminal acquires posture information based on image information;

FIG. 15 is a view for describing an example when the portable information terminal acquires posture information based on image information;

FIG. 16 is a view for describing an example when the portable information terminal acquires posture information based on image information; and

FIG. 17 is a schematic block diagram showing an example of the configuration of a portable information terminal according to a second example embodiment of the present invention.

### EXAMPLE EMBODIMENTS

### First Example Embodiment

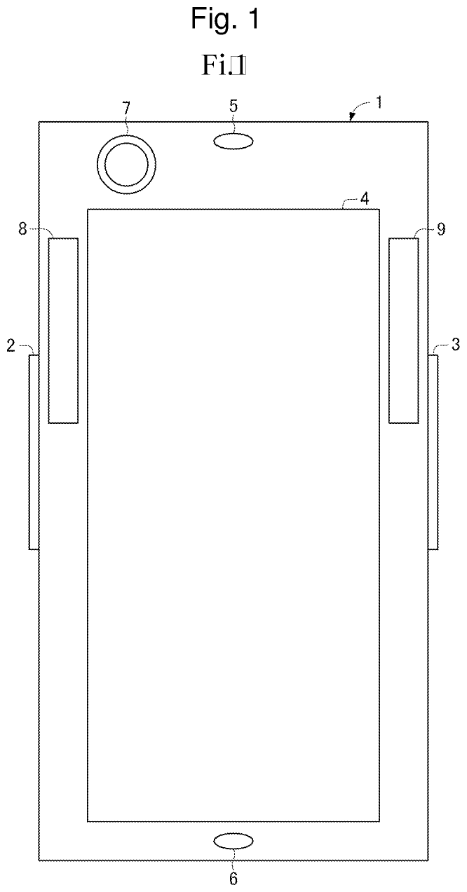

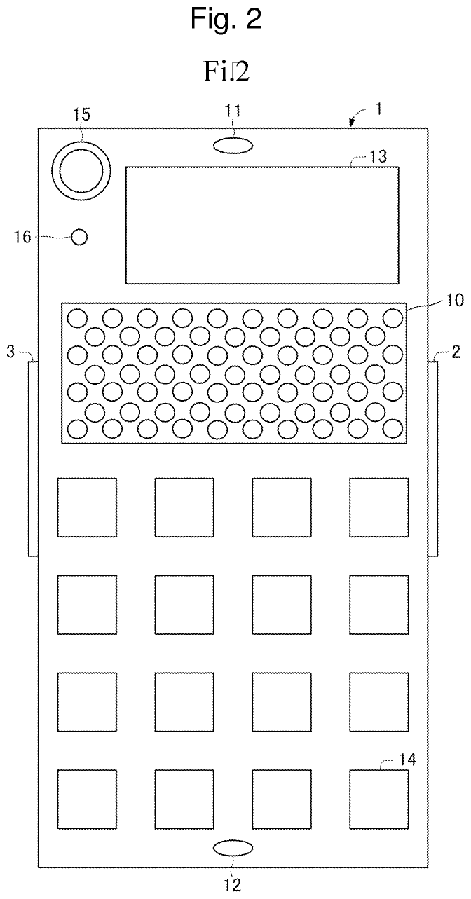

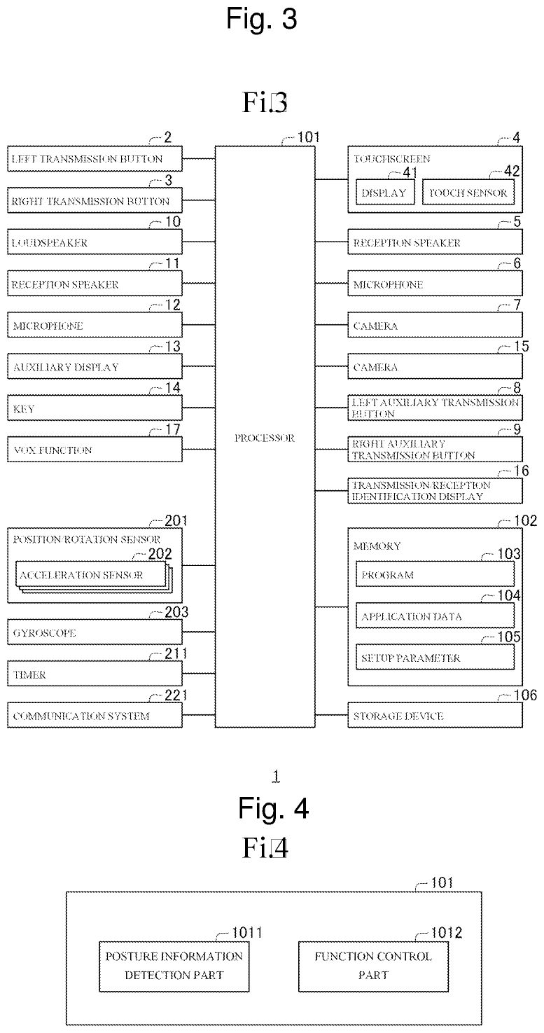

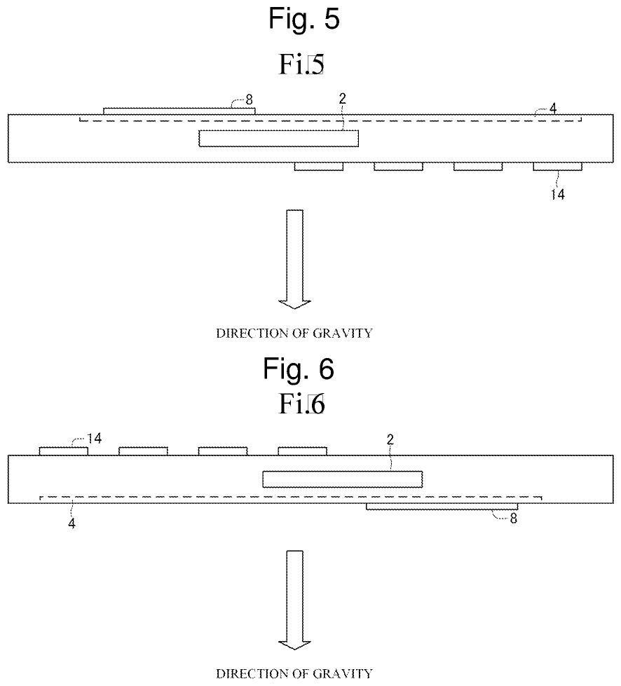

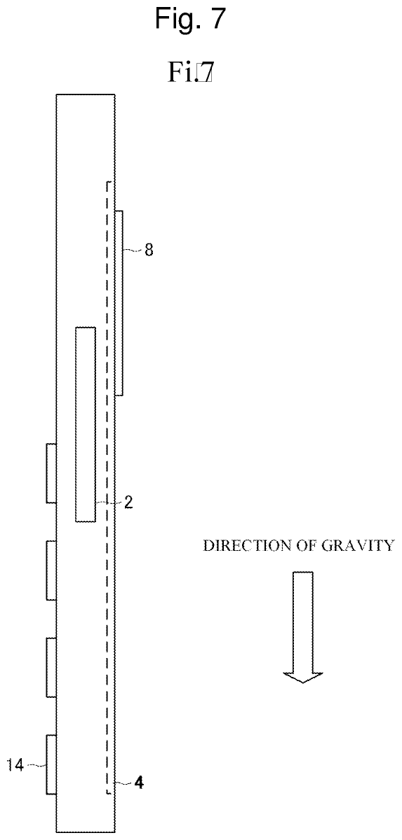

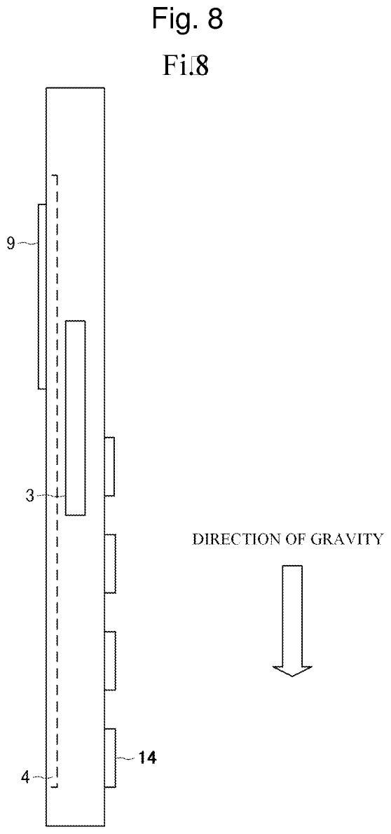

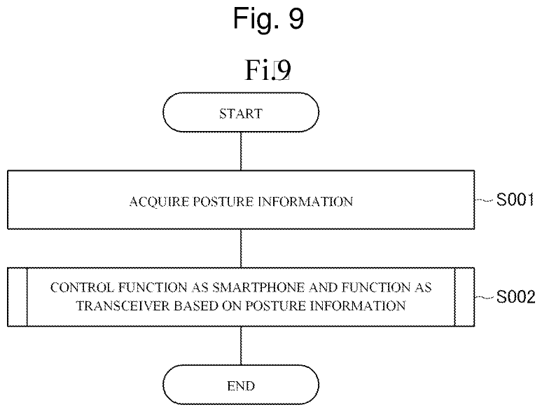

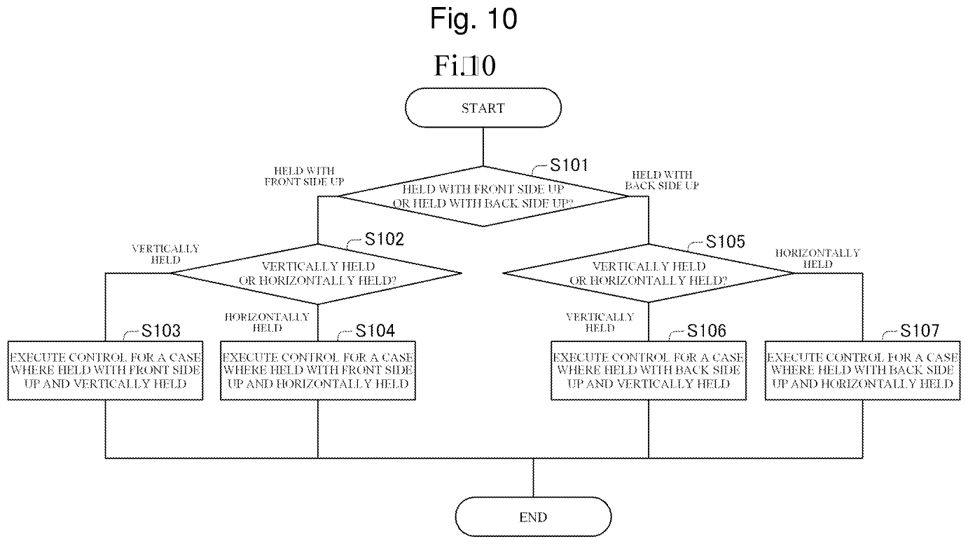

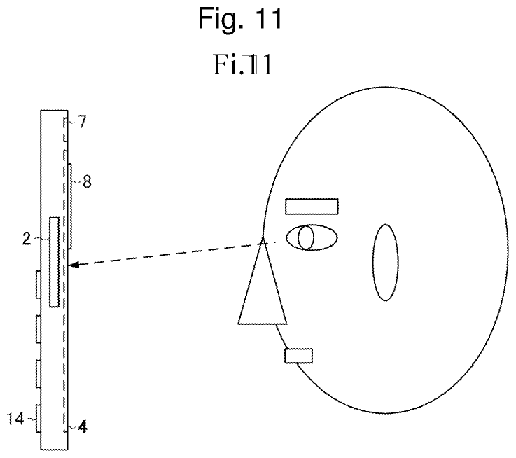

A first example embodiment of the present invention will be described with reference to FIGS. 1 to 16. FIG. 1 is a front view showing an example of a portable information terminal 1. FIG. 2 is a back view showing an example of the portable information terminal 1. FIG. 3 is a block diagram showing an example of the configuration of the portable information terminal 1. FIG. 4 is a function block diagram showing an example of a function realized by a processor 101. FIG. 5 is a view showing an example of a state in which the user holds the portable information terminal 1 with the front side up. FIG. 6 is a view showing an example of a state in which the user holds the portable information terminal 1 with the back side up. FIG. 7 is a view showing an example of a state in which the user vertically holds the portable information terminal 1 held with the front side up. FIG. 8 is a view showing an example of a state in which the user vertically holds the portable information terminal 1 held with the back side up. FIGS. 9 and 10 are flowcharts showing an example of a flow when the portable information terminal 1 controls a function. FIGS. 11 to 16 are views for describing an example when the portable information terminal 1 acquires posture information based on image information.

In the first example embodiment, the portable information terminal 1 that has a function as a smartphone and also has a function as a transceiver will be described. The portable information terminal 1 in this example embodiment has, on one face (for example, the front side) thereof, a configuration as a smartphone used when a function as a smartphone is mainly used. Moreover, the portable information terminal 1 has, on the other face (for example, the back side) thereof, a configuration as a transceiver used when a function as a transceiver is mainly used. As will be described later, the portable information terminal 1 in this example embodiment acquires posture information showing the posture, such as orientation and inclination, of the portable information terminal 1. Then, based on the acquired posture information, the portable information terminal 1 controls various functions included by the portable information terminal 1 itself, such as the smartphone function and the transceiver function. By thus performing control of functions based on posture information, it is possible to selectively use the functions without deteriorating the operability of the portable information terminal 1 having the smartphone function and the transceiver function, and it is also possible to suppress power consumption and radio wave interference.

Referring to FIGS. 1 and 2, the portable information terminal 1 has a substantially rectangular shape in front view, and is formed by a single case which has a predetermined thickness. On the front side of the portable information terminal 1, a configuration used in a smartphone mode to mainly use the smartphone function is installed (associated) (FIG. 1). On the other hand, on the back side of the portable information terminal 1 (that is, a face of the case opposite to the face where the smartphone configuration is installed), a configuration used in a transceiver mode of mainly using the transceiver function is installed (associated) (FIG. 2). The portable information terminal 1 may have the configuration as the transceiver on the front side and has the smartphone configuration on the back side. Moreover, the shape of the portable information terminal 1 is not limited to a substantially rectangular shape. For example, the portable information terminal 1 may have any shape that has a face associated with the smartphone function and a face associated with the transceiver function

FIG. 1 is a front view of the portable information terminal 1. Referring to FIG. 1, a touchscreen 4, a reception speaker 5, a microphone 6 and a camera 7 are installed on the front side of the portable information terminal 1. Thus, a general smartphone configuration is installed on the front side of the portable information terminal 1. Moreover, a left auxiliary transmission button 8 and a right auxiliary transmission button 9 can be installed on the front side of the portable information terminal 1.

The touchscreen 4 includes a display 41 and a touch sensor 42 as shown in FIG. 3. The display 41 is configured by a flat display device of liquid crystal, organic EL, or the like. The display 41 displays predetermined information (image information) such as characters and figures, and a still image and a moving image thereof. The touch sensor 42 detects an external contact and an approach of an object, and also detects the position of the contact or approach.

In this example embodiment, a method used when the touch sensor 42 detects an external contact is not particularly limited.

The reception speaker 5 outputs voice information to the outside based on an instruction from a processor 101 or the like to be described later. For example, the reception speaker 5 outputs received voice when the portable information terminal 1 is operated as a handset of a telephone in the smartphone mode.

The microphone 6 inputs voice information. For example, the microphone 6 inputs voice information such as transmitted voice when the portable information terminal 1 is operated as a handset of a telephone in the smartphone mode.

The camera 7 inputs visual information (still image information, moving image information) of the surroundings of the portable information terminal 1. As will be described later, visual information is also used for the purpose of detecting posture information of the portable information terminal 1.

There is a case where the portable information terminal 1 is used as a transceiver even in the smartphone mode.

The left auxiliary transmission button 8 and the right auxiliary transmission button 9 are buttons for inputting a request for switching to a transmission state when the portable information terminal 1 is used as a transceiver in the smartphone mode. The left auxiliary transmission button 8 and the right auxiliary transmission button 9 are, for example, installed on the outside of the case configuring the portable information terminal 1 so as to be exposed therefrom, and are configured to be able to be pressed toward the case. The left auxiliary transmission button 8 and the right auxiliary transmission button 9 may be touch sensors, or the like.

In the example shown in FIG. 1, buttons are installed on the left and right sides of the case, for example, the left auxiliary transmission button 8 and the right auxiliary transmission button 9 are installed so that the operator of the portable information terminal 1 can select a button to use depending on the handedness (right handed or left handed) of the operator. Meanwhile, the portable information terminal 1 may be provided with only either the left auxiliary transmission button 8 or the right auxiliary transmission button 9. When the portable information terminal 1 is used in the smartphone mode, the finger of the operator of the portable information terminal 1 is often located on the touchscreen 4. Therefore, by installing the left auxiliary transmission button 8 and the right auxiliary transmission button 9 on the front side of the portable information terminal 1, it is possible to suppress movement of the finger of the operator of the portable information terminal 1 to a small size, and the convenience is improved.

The above is an example of the respective components installed on the front side of the portable information terminal 1. Subsequently, an example of the respective components installed on the back side of the portable information terminal 1 will be described with reference to FIG. 2.

FIG. 2 is a back view of the portable information terminal 1. Referring to FIG. 2, a loudspeaker 10, a reception speaker 11, a microphone 12, an auxiliary display 13, keys 14 (operation keys), a camera 15, and a transmission/reception identification display 16 are installed on the back side of the portable information terminal 1. Thus, a general transceiver configuration is installed on the back side of the portable information terminal 1.

The loudspeaker 10 outputs voice information including received voice. The received voice is, in addition to voice for individual communication sent from an individual communication partner, broadcast voice sent from a base station or a command station to a plurality of terminals.

The reception speaker 11 outputs voice information to the outside based on an instruction from a processor 101 or the like to be described later. For example, the reception speaker 11 outputs voice information mainly composed of received voice, when the portable information terminal 1 is operated as a handset of a telephone in the transceiver mode.

The microphone 12 inputs voice information. For example, the microphone 12 inputs voice information mainly composed of transmitted voice when the portable information terminal 1 is operated as a handset of a telephone in the transceiver mode.

The auxiliary display 13 is configured by a flat display device of liquid crystal, organic E or the like. The auxiliary display 13 displays predetermined image information such as characters and figures, and a still image and a moving image thereof.

The keys 14 are installed so as to be exposed to the outside of the case, and are configured to be able to be pressed toward the case side. The keys 14 may be touchscreen keys.

In this example embodiment, as shown in FIG. 2, the keys 14 are arranged in four rows and four columns, that is, arranged in four rows so as to be four keys in each row. Moreover, the keys 14 protrude externally from the case. However, the arrangement of the keys 14 is not limited to being in four rows and 4 columns, and is not limited to protruding externally from the case. The keys 14 may be arranged in, for example, three rows and three columns, or six rows and three columns. Moreover, the keys 14 may be installed in a depressed place to prevent an object from coming in contact and causing malfunction.

The camera 15 inputs visual information (still image information, moving image information) of the surroundings of the portable information terminal 1. As will be described later, visual information is also used for the purpose of detecting posture information of the portable information terminal 1.

In a case where the portable information terminal 1 is used as a transceiver, the transmission/reception identification display 16 displays identification information so that it is possible to visually identify whether the portable information terminal 1 is in the transmission state or the reception state. The transmission/reception identification display 16 displays identification information, for example, by turning on/off, lightness/darkness, a blinking time interval or a color change of a light emitter such as a light bulb and a light emitting diode, and a combination thereof. It should be noted that an icon or a character may be displayed as identification information on the display 41 or the auxiliary display 13, along with displaying identification information by using the transmission/reception identification display 16 or instead of displaying identification information by using the transmission/reception identification display 16.

The above is an example of the components installed on the back side of the portable information terminal 1.

Subsequently, a configuration installed on the side face of the portable information terminal 1 will be described. As shown in FIGS. 1 and 2, the left transmission button 2 and the right transmission button 3 are installed on the side face of the portable information terminal 1.

To be specific, as show in FIGS. 1 and 2, the left transmission button 2 is installed on a left side face (a side face located leftward in front view) located on the left side of the face where the touchscreen 4 is installed of the case of the portable information terminal 1. Moreover, the right transmission button 3 is installed on a right side face (a side face located rightward in front view) located on the right side of the face where the touchscreen 4 is installed of the case of the portable information terminal 1.

The left transmission button 2 and the right transmission button 3 are buttons for inputting a request for switching to the transmission state in a case where the portable information terminal 1 is used as a transceiver regardless that it is used in the smartphone mode or the transceiver mode. In this example embodiment, the left transmission button 2 and the right transmission button 3 are installed so as to be exposed to the outside of the case and configured to be able to be pressed toward the case. The left transmission button 2 and the right transmission button 3 may be touch sensors. In this example embodiment, the left transmission button 2 and the right transmission button 3 are installed so that the operator can select according to the handedness (right handed or left handed) of the operator. However, the portable information terminal 1 may have only either the left transmission button 2 or the right transmission button 3.

The above is an example of the components installed on the side face of the portable information terminal 1.

The portable information terminal 1 has, for example, the configurations as described above on the front side, back side and side face of the case of the portable information terminal 1 itself. By thus separately installing the smartphone configuration and the configuration as the transceiver on the front side and the back side of the portable information terminal 1, it is possible to mount the touchscreen 4, the loudspeaker 10 and so on having sufficient sizes to secure a necessary functional level as a portable information terminal on the portable information terminal 1, without excessively increasing the size of the portable information terminal 1.

In this example embodiment, a case where the display device mounted on the portable information terminal 1 is the touchscreen 4 including the display 41 provided with the touch sensor 42 has been illustrated. However, the display device of the portable information terminal 1 may include only the display 41.

Subsequently, with reference to FIG. 3 showing a block diagram of the portable information terminal 1 of the present invention, the respective components of the portable information terminal 1 will be described in more detail.

Referring to FIG. 3, for example, the portable information terminal 1 has a processor 101 (a control device) that controls the operation of the portable information terminal 1 itself, and a memory 102 and a storage device 106 for storing information, in addition to the components installed on the front side, back side and side face of the case of the portable information terminal 1. Moreover, the portable information terminal 1 has a position/rotation sensor 201, a gyroscope 203, a timer 211 and so on that can be used for acquiring posture information of the portable information terminal 1. Besides, the portable information terminal 1 has a communication system 221 used for communicating with the outside.

The processor 101 performs logical operation processing and numerical operation processing. Moreover, the processor 101 includes a function as the interface with the outside to perform processing of input/output of digital information such as logics and also perform processing of input/output of analog information such as voice signals and image signals. The processor 101 is connected to each of the components included by the portable information terminal 1, and controls the operation of each of the components. The processor 101 may be configured by a single processor, or may be configured by a plurality of processors.

For example, referring to FIG. 3, the processor 101 is connected with the left transmission button 2, the right transmission button 3, the left auxiliary transmission button 8, the right auxiliary transmission button 9, and the keys 14. Into the processor 101, an output (a press signal or a contact signal) from each of the components described above is input.

Further, the processor 101 is connected with the touchscreen 4. An output (a touch signal) from the touch sensor 42 of the touchscreen 4 is input into the processor 101. Moreover, an output (image information) from the processor 101 is output to the display 41 of the touchscreen 4. Meanwhile, as a modification example, there is a case where, not the touchscreen 4 incorporating the touch sensor 42 as described above, only the display 41 is connected to the processor 101. Moreover, the processor 101 is connected with the auxiliary display 13. The processor 101 can also output image information to the auxiliary display 13.

Further, the processor 101 is connected with the reception speaker 5, the reception speaker 11, and the loudspeaker 10. The processor 101 outputs voice signals to the reception speaker 5, the reception speaker 11, and the loudspeaker 10.

Further, the processor 101 is connected with the microphone 6 and the microphone 12. Into the processor 101, outputs (voice signals) from the microphone 6 and the microphone 12 are input.

Further, the processor 101 is connected with the camera 7 and the camera 15. Into the processor 101, outputs (image signals) from the camera 7 and the camera 15 are input. Moreover, the processor 101 controls the camera 7 and the camera 15.

Further, the processor 101 is connected with the transmission/reception identification display 16. Depending on the state of the portable information terminal 1 (in the transmission state or in the reception state), the processor 101 displays identification information by turning on/off, lightness/darkness, a blinking time interval or color change of a light emitter such as a light bulb and a light emitting diode, and a combination thereof.

Further, the processor 101 is connected to a VOX (Voice Operated Relay) function 17.

The VOX function is a function of comparing the sound volume of an input into the microphone such as the microphone 12 with a predetermined reference sound volume and, when the sound volume of the input is larger than the reference sound volume, determines that a voice to be transmitted has been input, generates a transmission instruction signal, and switches from reception to transmission. The processor 101 in this example embodiment controls the VOX function 17.

Further, the processor 101 is connected with the timer 211. The processor 101 outputs timekeeping control information (timekeeping start timing, timekeeping end timing, or the like) to the timer 211, and timekeeping result information (an elapsed time, timekeeping end notification information, or the like) from the timer 211 is input therein. The timer 211 can keep time simultaneously for a plurality of events that require timekeeping. There may be a plurality of timers 211 depending on the number of events that require timekeeping.

Further, the processor 101 is connected with the memory 102. In the memory 102, a program 103 including an operating system and an application program executed by the processor 101, application data 104 used by the application program, and various information such as a setup parameter 105 that is setup information related to program execution are stored. Each of the information stored in the memory 102 is input to and output from the processor 101.

Further, the processor 101 is connected with the storage device 106. What is stored in the memory 102 is basically erased in the power-off state. Therefore, information that is not wanted to be erased in the power-off state is stored into the storage device 106 and retrieved to the memory 102 via the processor 101 when necessary. As the storage device 106, other than a disk drive, a nonvolatile storage device such as a flash memory is used.

Further, the processor 101 is connected with a communication system 221 that is an interface with an external network. The processor 101 is connected with an external network via the communication system 221. A method for connecting with an external network is, other than wired connection, wireless connection using electromagnetic waves, light, or sound waves. An example of the external network to which the processor 101 is connected is the Internet, mobile telephone network, or the like. A physical example is a wired communication specification such as Ethernet™ and Universal Serial Bus (USB), and a wireless communication specification such as Global System for Mobile communications (GSM)™, Wideband Code Division Multiple Access (WCDMA)™, Long Term Evolution (LTE), Wi-Fi, infrared communication, and an acoustic modem.

Further, the processor 101 is connected with the position/rotation sensor 201. The position/rotation sensor 201 detects a change in the position of the portable information terminal 1, a change in the orientation of the case and the direction of gravity applied to the portable information terminal 1, and inputs acceleration information into the processor 101. The position/rotation sensor 201 in this example embodiment is configured by a plurality of acceleration sensors 202. For example, the position/rotation sensor 201 includes five acceleration sensors 202. The case of the portable information terminal 1 can be regarded as a rigid body, and an acceleration (in three axis directions) related to position coordinates of the center of gravity and an acceleration (in two axis directions) related to rotation of the case are detected, for example.

Further, the processor 101 is connected with the gyroscope 203. The gyroscope 203 detects a change in the orientation of the case and inputs into the processor 101.

Further, referring to FIG. 4, the processor 101 executes the program 103 stored in the memory 102 or the storage device 106, thereby realizing a posture information detection part 1011 (a posture information acquisition part) and a function control part 1012.

The posture information detection part 1011 detects a change in the position of the portable information terminal 1, a change in the orientation of the case and the direction of the gravity applied to the portable information terminal 1 based on, for example, information input from the position/rotation sensor 201 or the gyroscope 203. To be specific, the portable information terminal 1 detects acceleration in a predetermined axial direction by using a plurality of (for example, five) acceleration sensors 202. Then, the detected acceleration information is input to the posture information detection part 1011 of the processor 101. The posture information detection part 1011 obtains acceleration information and angular acceleration information of the case from the input acceleration information of each of the acceleration sensors 202, and performs integration of each acceleration information to obtain velocity information, angular velocity information, displacement information and angle information of the case. Moreover, the gyroscope 203 detects the orientation of the case and inputs the detected orientation to the posture information detection part 1011 of the processor 101. The posture information detection part 1011 can obtain angle information, angular velocity information and angular acceleration information from the case orientation information input from the gyroscope 203.

Further, the posture information detection part 1011 detects and acquires posture information of the portable information terminal 1 based on, for example, the information from the position/rotation sensor 201 and the gyroscope 203. Then, the posture information detection part 1011 transmits the acquired posture information to the function control part 1012.

For example, it is assumed that, as shown in FIG. 5, it is detected that the direction of the gravity is from the front side to the back side of the portable information terminal 1 based on information from the position/rotation sensor 201 and the gyroscope 203. In other words, it is assumed that the front side of the case of the portable information terminal 1 faces upward (in the opposite direction to a direction toward the earth). When it is detected that the front side of the case faces upward as described above, the posture information detection part 1011 determines that the portable information terminal 1 is “held with the front side up.” Then, the posture information detection part 1011 acquires information of being “held with the front side up” (first posture information) as posture information.

In a case where the operator operates the portable information terminal 1 while grasping and visually recognizing the portable information terminal 1, the height of the portable information terminal 1 is often the same as or lower than the height of the operator's eyes in general. In this case, the operator of the portable information terminal 1 is looking at the upper side of the portable information terminal 1. That is, in a case where the posture information of the portable information terminal 1 is “held with the front side up,”it is highly possible that the operator of the portable information terminal 1 is present on the side having the configuration as the smartphone and using the function as the smartphone such as the touchscreen 4 located on the upper side. Therefore, when the posture information detection part 1011 recognizes that the portable information terminal 1 is held with the front side up, the function control part 1012 of the processor 101 estimates that the operator is looking down the front side of the portable information terminal 1, and executes control on each function (each configuration) according to the estimation.

On the other hand, for example, it is assumed that, as shown in FIG. 6, it is detected that the direction of the gravity is from the back side to the front side of the portable information terminal 1 based on information from the position/rotation sensor 201 and the gyroscope 203. That is, it is assumed that the back side of the case of the portable information terminal 1 faces upward. When it is detected that the back side of the case faces upward as described above, the posture information detection part 1011 determines that the portable information terminal 1 is “held with the back side up.” Then, the posture information detection part 1011 acquires information of being “held with the back side up” (second posture information) as posture information.

Thus, in a case where the posture information of the portable information terminal 1 is “held with the back side up,” it is highly probable that the operator of the portable information terminal 1 is on the side having the configuration as the transceiver and using the function as the transceiver such as the loudspeaker 10 located on the upper side. Therefore, when the posture information detection part 1011 recognizes that the portable information terminal 1 is held with the back side up, the function control part 1012 of the processor 101 estimates that the operator is looking down the back side of the portable information terminal 1, and executes control on each function (each configuration) according to the estimation.

Further, the posture information detection part 1011 determines whether the portable information terminal 1 is “vertically held” or “horizontally held” based on the information from the position/rotation sensor 201 and the gyroscope 203. In other words, the posture information detection part 1011 acquires posture information of “vertically held” indicating that the portable information terminal 1 is substantially vertical to the ground, based on the information from the position/rotation sensor 201 and the gyroscope 203. Moreover, the posture information detection part 1011 acquires posture information of “horizontally held” indicating that the portable information terminal 1 is substantially horizontal to the ground, based on the information from the position/rotation sensor 201 and the gyroscope 203. For example, it is assumed that, as shown in FIGS. 7 and 8, it is detected that the gravity is applied from the upper side to the lower side of the portable information terminal 1 (in FIG. 1, for example, in the direction from the reception speaker 5 to the microphone 6), based on the information from the position/rotation sensor 201 and the gyroscope 203. When it is detected that the gravity is applied in a direction to longitudinally run through the portable information terminal 1 as described above, the posture information detection part 1011 determines that the portable information terminal 1 is “vertically held.” Then, the posture information detection part 1011 acquires information of “vertically held” (third posture information) as posture information. Moreover, the function control part 1012 executes control according to the “vertically held” state. It should be noted that the posture information detection part 1011 may be configured to determine that the portable information terminal 1 is “vertically held” when the gravity is applied from the lower side to the upper side of the portable information terminal 1 (in FIG. 1, for example, in a direction from the microphone 6 to the reception speaker 5).

Besides, the “vertically held” state may include a state where the gravity is applied in a direction from the left auxiliary transmission button 8 to the right auxiliary transmission button 9 (also a direction from the right auxiliary transmission button 9 to the left auxiliary transmission button 8). That is, the “vertically held” state may include the state where the gravity is applied not only in the vertical direction shown in FIG. 1 but also in the horizontal direction.

On the other hand, it is assumed that, as shown in FIGS. 5 and 6, it is detected that the gravity is applied from the front side to back side or applied from the back side to the front side. In a case where it is detected that the gravity is applied in the thickness direction of the portable information terminal 1 as described above, the posture information detection part 1011 determines that the portable information terminal 1 is “horizontally held.” Then, the posture information detection part 1011 acquires information of “horizontally held” (fourth posture information) as posture information.

To summarize the above description, for example, in the example shown by FIG. 5, the posture information detection part 1011 acquires posture information of “held with the front side up” and “horizontally held.” Moreover, for example, in the case shown by FIG. 6, the posture information detection part 1011 acquires posture information of “held with the back side up” and “horizontally held.”

Further, in the case shown by FIGS. 7 and 8, the posture information detection part 1011 acquires posture information of “vertically held.” Regarding whether the portable information terminal 1 is in the “held with the front side up” state or “held with the back side up” state in the “vertically held” state, for example, times during which the portable information terminal 1 is in the respective states within a predetermined time are kept by the timer 211 and it is estimated that the operator has used in the state kept in a longer time. That is, in a case where the time during which the portable information terminal 1 is held with the front side up for a longer time within a predetermined time, the posture information detection part 1011 acquires posture information of “held with the front side up” and “vertically held.” On the other hand, in a case where the portable information terminal 1 is held with the back side up for a longer use time within the predetermined time, the posture information detection part 1011 acquires posture information of “held with the back side up” and “vertically held.”.

Further, it is thought that the operator operates the portable information terminal 1 in a posture intended to use and the operator does not operate in other postures. Therefore, it may be estimated that a detection value when operation by the operator is received shows the current posture, and posture information may be acquired.

FIGS. 5 to 8 illustrate a case where the portable information terminal 1 has rotated 90 degrees. However, a unit of rotation angle of the portable information terminal 1 is not limited to 90 degrees, and may be 30 degrees or 68 degrees, which is an angle between the state shown by FIGS. 5, 6 and the state shown by FIGS. 7, 8. In such a case, a reference for classification of considering as being vertically held or as being horizontally held (an angle reference threshold value) may be set to any value. For example, the posture information detection part 1011 may be configured to, in a case where the portable information terminal 1 is rotated 90 degrees from the state shown in FIG. 5 to the state shown in FIG. 7, determine a state where rotated up to 45 degrees from the sate shown in FIG. 5 as being horizontally held, and determines a state where rotated up to 90 degrees shown in FIG. 7 from 45 degrees as being vertically held. Alternatively, the posture information detection part 1011 may be configured to, in a case where the portable information terminal 1 is rotated 90 degrees from the state shown in FIG. 5 to the state shown in FIG. 7, determine a state where rotated up to 60 degrees from the state shown in FIG. 5 as being horizontally held, and determine a state where rotated up to 90 degrees shown in FIG. 7 from 60 degrees as being vertically held. Accordingly, the reference threshold value can be set to any value. Besides, the same is true for a case of inverse rotation.

By providing the reference threshold with hysteresis, it is possible to prevent that the posture information detection part 1011 excessively sensitively responds to a small change in the posture and change of posture information frequently occurs. The reference threshold may be defined for each function controlled with reference to the reference threshold.

Further, an angle to determine whether the portable information terminal 1 is “held with the front side up” or “held with the back side up” from a complete “vertically held” state (a state where the gravity is not applied in the thickness direction of the portable information terminal 1) may be set to any angle. For example, the posture information detection part 1011 can be configured to determine “held with the front side up” or “held with the back side up” at a stage inclined 30 degrees from the complete “vertically held” state. The posture information detection part 1011 may be configured to determine “held with the front side up” or “held with the back side up,” for example, when the portable information terminal 1 is inclined even 1 degree from the complete “vertically held” state.

The function control part 1012 executes control on various functions of the portable information terminal 1 based on posture information acquired by the posture information detection part 1011. That is, the function control part 1012 controls the function as the smartphone and the function as the transceiver based on posture information acquired by the posture information detection part 1011.

For example, in a case where the posture information detection part 1011 acquires posture information of “held with the front side up,” it is estimated that the function as the smartphone of the portable information terminal 1 is mainly used, that is, the smartphone mode is selected. Then, the function control part 1012, for example, stops the function as the transceiver. Moreover, the function control part 1012 regulates the function as the smartphone depending on the state such as “vertically held” and “horizontally held.”

To be specific, for example, the function control part 1012 executes predetermined control such as:
estimates that the loudspeaker 10 does not face the operator of the portable information terminal 1 and stops the operation of the loudspeaker 10;
estimates that the microphone 12 does not face the operator of the portable information terminal 1 and stops the operation of the microphone 12;
estimates that the keys 14 do not face the operator of the portable information terminal 1 and stops the operation of the keys 14;
stops the operation of a simplex transmission/reception switching function of the transceiver mode;
stops the operation of a function to mask a simplex transmission button function of the transceiver mode;
stops the operation of a simplex transmission button switching function of the transceiver mode;
stops the operation of a function to mask a simplex VOX function of the transceiver mode.

Thus, in a case where the posture information detection part 1011 acquires posture information of “held with the front side up,” the function control part 1012 stops the function as the transceiver of the portable information terminal 1. The function control part 1012 may control to execute the function as the transceiver in a lower power consumption state.

Moreover, the function control part 1012 may execute any one of the controls exemplified above, or may execute a plurality of controls in combination.

Further, the function control part 1012 sets the portable information terminal 1 to a duplex mode. That is, the function control part 1012 selects a communication system (WCDMA, LTE, GSM, and the like) capable of duplex communication for the portable information terminal 1. Moreover, the function control part 1012 activates a circuit that supports the selected communication system. Then, the function control part 1012 controls the portable information terminal 1 so as to start operation to connect to the selected communication system. In the case of having operated in the simplex mode at the last minute, the function control part 1012 can end connection to the communication system used therein and stop a circuit to connect to the simplex-mode communication system. However, simplex operation supported in the communication system (WCDMA, LTE, GSM or the like) capable of duplex communication may be executed in the duplex mode.

Furthermore, the function control part 1012 executes the following control according to “vertically held” or “horizontally held” while the portable information terminal 1 is “held with the front side up:”
display adjustment;
start/stop of the display 41;
start/stop of the camera; and
start/stop of the touch sensor.

To be specific, when detecting that the display 41 is facing upward (horizontally held) while an image is displayed in the vertically held state, the function control part 1012 executes control of display adjustment such as:
increases the luminance of the display 41; and
zooms in part of the image displayed on the display 41.

On the other hand, when detecting that the portable information terminal 1 has shifted from the horizontally held state as described above to the vertically held state, the function control part 1012 executes control of display adjustment such as:
decreases the luminance of the display 41; and
zooms out the enlarged image and again displays the image that cannot be displayed when zoomed in.

When the display 41 is turned upward (horizontally held) at the time of displaying image information, it is estimated that a plurality of persons are simultaneously browsing and sharing the image information displayed on the display 41. Then, the function control part 1012 executes the processing as described above. In the horizontally held state as described above, the viewers' eyes are far from the display 41 as compared with when the operator browses alone, so that the visibility by the viewers is lowered. However, by execution of the abovementioned control by the function control part 1012, it is possible to compensate visibility and reduce power consumption.

Further, when detecting that the display 41 is turned upward (horizontally held) in a state where the portable information terminal 1 is vertically held and is not displaying an image, the function control part 1012 executes control to start the display 41 such as:
causes the display 41 to display an image; and
starts the display 41 or powers on the display 41.

On the other hand, when detecting the portable information terminal 1 has shifted from the horizontally held state as described above to the vertically held state, the function control part 1012 executes control to stop the display 41 such as:
causes the display 41 to stop displaying the image; and
stops the display 41 or powers off the display 41.

When the display 41 is turned upward (horizontally held) while not displaying image information, it is estimated that the operator intends to cause the display 41 to display image information in order to browse. Thus, with the configuration as described above, the display 41 displays/starts without operation to instruct to display or start, so that convenience increases. Moreover, by executing control to stop the display 41 when the portable information terminal 1 comes in the “vertically held” state, it is possible to stop displaying except at the time of browsing, so that it is possible to suppress power consumption.

Further, when detecting that the line of sight of the camera 15 is directed to the horizontal direction (the portable information terminal 1 has shifted to the vertically held state) in a state where the line of sight of the camera 15 (the camera 7) is in the vertical direction (the horizontally held state) and the camera 15 is not performing image input operation, the function control part 1012 executes control to start the camera 15 (the camera 7) such as:
starts the camera 15 or powers on the camera 15 (it may be configured to start the camera 7).

On the other hand, when detecting that the line of sight of the camera 15 is directed to the vertical direction (the portable information terminal 1 has shifted to the horizontally held state) in a state where the line of sight of the camera 15 (the camera 7) is in the horizontal direction (the vertically held state) and an image is input, the function control part 1012 executes control to stop the camera 15 (the camera 7) such as:
stops the camera 15 (the camera 7) or powers off the camera 15.

A camera is more often used in a state where the line of sight is directed to the horizontal direction (vertically held), than in a state where the line of sight is directed to the vertical direction, for example, turned to the ground (horizontally held). Therefore, it is estimated that the operator intends to input an image when vertically holding, whereas it is estimated that the operator does not intend to input an image when horizontally holding. According to the abovementioned configuration, the camera starts without an operation to instruct to start the camera such as pressing a button, so that convenience increases. Moreover, it is possible to shorten a time required to start the camera by the amount of time required for operation. Therefore, it is possible to start image input in a timely manner.

Further, when detecting that the portable information terminal 1 has shifted from the vertically held state to the horizontally held state that is a state where the touchscreen 4 faces opposite to the vertical direction (in the opposite direction to the gravity), the function control part 1012 executes control to start the touchscreen 42 such as:
powers on the touch sensor 42;
causes the touch sensor 42 to transit from a power-saving operation state to a faster operation state; and
starts processing by the processor 101 relating to the touch sensor 42.

On the other hand, when detecting that the touchscreen 4 has shifted from the horizontally held state to the vertically held state, the function control part 1012 executes control to stop the touch sensor 42 such as:
powers off the touch sensor 42;
causes the touch sensor 42 to shift to a more power-saving operation state; and stops processing by the processor 101 relating to the touch sensor 42.

When the operator operates the touchscreen 4, it is easier to operate with the operator's finger put on the surface of the touchscreen 4 according to the gravity than operate in a state where the touchscreen 4 erects or is directed vertically downward (in the gravity direction). Therefore, when it is detected that the touchscreen 4 has shifted to a state of being directed vertically upward (in the opposite direction to the gravity direction), that is, shifted to the horizontally held state, it is estimated that the operator will operate the touchscreen 4. On the contrary, when it is detected that the touchscreen 4 has shifted to a state which is not the state of being directed vertically upward (in the opposite direction to the gravity direction), that is, shifted to the vertically held state, it is estimated that the operator has stopped operating the touchscreen 4. According to the abovementioned configuration, power and operation of the touch sensor 42 of the touchscreen 4 and related processing by the processor are controlled based on the above estimation, so that it is possible to suppress power consumption.

For example, as described above, the function control part 1012 executes control depending on “vertically held” or “horizontally held” in the “held with the front side up” state.

In other words, in a case where the portable information terminal 1 is “held with the front side up” and “vertically held,” the function control part 1012 starts a function (the camera 15, and so on) expected to be used when the portable information terminal 1 is directed in the substantially perpendicular direction to the ground, whereas stops a function (the display 41, the touchscreen 42, and so on) not expected to be used. On the other hand, in a case where the portable information terminal 1 is “held with the front side up” and “horizontally held,” the function control part 1012 starts a function (the display 41, the touch sensor 42, and so on) expected to be used when the portable information terminal 1 is directed in the substantially horizontal direction to the ground, whereas stops a function (the camera 15, and so on) not expected to be used. The function control part 1012 may be configured to execute only one of the controls described above, or may be configured to execute some of the controls described above in combination. The function control part 1012 may be configured to be able to select control to execute depending on “vertically held” or “horizontally held”

Further, for example, in a case where the posture information detection part 1011 acquires posture information of “held with the back side up,” it is estimated that the function as the transceiver of the portable information terminal 1 is mainly used, that is, the transceiver mode is selected. Then, the function control part 1012, for example, stops the function as the smartphone. Moreover, the function control part 1012 regulates the function as the transceiver depending on the state such as “vertically held” and “horizontally held.”

To be specific, for example, the function control part 1012 estimates that the display 41 does not face the operator, and stops the operation of the display 41 or suppresses the capability compared to when the smartphone mode is selected (held with the front side up). When the camera 7 (the camera 15) uses the display 41 as a viewer, it is estimated that the camera 7 is not used, and the camera 7 does not execute operation to be executed in the smartphone mode. To be specific, the operation of the circuit related to the camera 7 is stopped due to stop of supply of power and clock, and the program for processing image information output from the camera 7 is stopped. Moreover, the function control part 1012 estimates that the touch sensor 42 does not face the operator, and the touch sensor 42 stops operation or suppresses the capability compared to when the smartphone mode (held with the front side up) is selected. To be specific, supply of power and clock to the circuit related to the touch sensor 42 is stopped, voltage and clock frequency supplied to the touch sensor 42 is lowered, and the program for processing position and time information output from the touch sensor 42 is stopped.

Thus, in a case where the posture information detection part 1011 acquires posture information of “held with the back side up,” the function control part 1012 stops the function as the smartphone of the portable information terminal 1. The function control part 1012 may execute any one of the controls exemplified above, or may execute a plurality of controls in combination.

Further, the function control part 1012 sets the portable information terminal 1 to a simplex mode. That is, the function control part 1012 selects a communication system of simplex communication (a communication system relating to public safety such as police, fire fighting and disaster prevention, the PTT mode in such as WCDMA, LTE and GSM). Moreover, the function control part 1012 starts a circuit that supports the selected communication system. Then, the function control part 1012 controls the portable information terminal 1 so as to start an operation of connection to the selected communication system. In the case of operating in a duplex mode at the last minute, the function control part 1012 can end connection to the communication system used therein and stop a circuit connected to the communication system of duplex mode.

Furthermore, the function control part 1012 executes the following control depending on “vertically held” or “horizontally held” in the “held with the back side up” state:
control of the speaker (the loudspeaker 10, the reception speaker 11);
control of the microphone 12;
switching of simplex transmission/reception;
masking simplex transmission button function;
switching of simplex transmission button; and
mask simplex VOX function.

To be specific, when detecting that the portable information terminal 1 has shifted from the vertically held state to a state where the loudspeaker 10 is directed vertically upward (in the opposite direction to the gravity direction), that is, to the horizontally held state, the function control part 1012 executes control of the speaker such as:
starts output of voice from the loudspeaker 10 or increases the sound volume;
switches so that a voice signal having been output from the other small-output speaker (the reception speaker 11 or the like) is output from the loudspeaker 10;
starts a processing circuit of the processor 101 outputting a voice signal to the loudspeaker 10; turns on amplifier circuits incorporated in both the loudspeaker 10 and the processor 101 or either one of them; and
raises the gains of the amplifier circuits incorporated in both the loudspeaker 10 and the processor 101 or either one of them.

On the other hand, when detecting that the portable information terminal 1 has shifted from the horizontally held state as described above to the vertically held state, the function control part 1012 executes control of the speaker such as:
stops output of voice from the loudspeaker 10 or decreases the sound volume; switches so that voice is output from the small-output speaker (the reception speaker 11 or the like) other than the loudspeaker 10;
stops a processing circuit of the processor 101 outputting a voice signal to the loudspeaker 10; turns off the amplifier circuits incorporated in both the loudspeaker 10 and the processor 101 or either one of them; and
lowers the gains of the amplifier circuits incorporated in both the loudspeaker 10 and the processor 101 or either one of them.

In the state of “held with the back side up,” which is the transceiver mode, a plurality of persons may simultaneously listen to voice output from the speaker, for example, when receiving simultaneous broadcast information. In such a case, the speaker is usually directed upward (horizontally held) so that the voice is efficiently spread around. Therefore, when it is detected that the loudspeaker 10 has shifted to a state of facing vertically upward (the opposite direction to the gravity direction), that is, to the horizontally held state, it is estimated that the operator intends to output voice from the loudspeaker 10 and expand the voice to the surroundings. On the contrary, when it is detected that the loudspeaker 10 has shifted to a state which is not the state of facing vertically upward (the opposite direction to the gravity direction, that is, the horizontally held state), that is, to the vertically held state, it is estimated that the operator intends to stop expanding the voice output from the loudspeaker 10. According to the above configuration, based on the estimation described above, starting/stopping voice output from the loudspeaker 10 and turning up/down the volume, switching between the loudspeaker 10 and the small-output speaker (such as the reception speaker 11), and the processing circuit and the amplifier circuit of the processor 101 are controlled. Therefore, power consumption can be suppressed. Moreover, since it is possible to instruct the control by a simple operation, the convenience is increased.

Further, when detecting that the microphone 12 has shifted from the state of facing vertically upward (the opposite direction to the gravity direction), that is, from the horizontally held state to the vertically held state, the function control part 1012 executes control of the microphone 12 such as:
starts voice input from the microphone 12;
switches so that a voice signal having been input from another microphone (not shown; for example, a speaker microphone, a headset, or the like) externally connected via wired or wireless connection is input from the microphone 12; and
starts a processing circuit of the processor 101 inputting the voice signal from the microphone 12.

On the other hand, when detecting that the microphone 12 has shifted from the vertically held state as described above to the horizontally held state, the function control part 1012 executes control of the microphone 12 such as:
stops voice input from the microphone 12;
switches so that voice is input from a microphone (not shown) externally connected via wired or wireless connection, other than the microphone 12; and
stops the processing circuit of the processor 101 inputting the voice signal from the microphone 12.

In the “held with the back side up” state, which is the transceiver mode, a plurality of persons may simultaneously listen to voice output from the speaker, whereas it is required to collect voice uttered from a specific speaking person in such a noisy environment. In such a scene, by making the mouth of the speaking person and a microphone (for example, the microphone 12) face each other (that is, by vertically holding) at the time of transmission, it is possible to input voice with high quality by also using the directionality of the microphone. Therefore, when it is detected that the microphone 12 has shifted from a state of facing vertically upward (the opposite direction to the gravity direction), that is, from the horizontally held state to the vertically held state, it is estimated that the operator intends to input voice through the microphone 12. On the contrary, when it is detected that the microphone 12 has shifted from the vertically held state to the horizontally held state, it is estimated that the operator intends to stop inputting voice through the microphone 12. According to the above configuration, based on the estimation described above, starting/stopping voice input through the microphone 12, switching between the microphone 12 and another microphone, and the processing circuit of the processor 101 are controlled. Therefore, power consumption can be suppressed. Moreover, since it is possible to instruct the control by a simple operation, the convenience is increased. The above control can also be applied to the microphone 6 in the smartphone mode.

Further, the function control part 1012 sets to a receiving state in the horizontally held state, and sets to a transmitting state in the vertically held state. That is, the function control part 1012 switches from the receiving state to the transmitting state when detecting shift from the horizontally held state to the vertically held state, whereas switches from the transmitting state to the receiving state when detecting shift from the vertically held state to the horizontally held state.

In the “held with the back side up” state, which is the transceiver mode, it is supposed to horizontally hold the portable information terminal 1 for expanding received voice signals and vertically hold for inputting voice signals to transmit. Therefore, when it is detected that the portable information terminal 1 has shifted from the horizontally held state to the vertically held state, it is estimated that the operator intends to input voice through the microphone 12 and transmit the voice. On the contrary, when it is detected that the portable information terminal 1 has shifted from the vertically held state to the horizontally held state, it is estimated that the operator intends to receive voice in order to output the voice through the loudspeaker 10. According to the above configuration, switching between reception and transmission is controlled based on the above estimation, so that the operator can switch transmission and reception of the portable information terminal 1 without the operator's operation of the left transmission button 2 or the right transmission button 3 (or the left auxiliary transmission button 8 or the right auxiliary transmission button 9). Therefore, the convenience increases.

Further, when it is detected that the portable information terminal 1 is in the horizontally held state, the function control part 1012 can set the portable information terminal 1 to the receiving state and mask the function of the transmission buttons (the left transmission button 2, the right transmission button 3, the left auxiliary transmission button 8, and the right auxiliary transmission button 9). On the other hand, when it is detected that the portable information terminal 1 is in the vertically held state, the function control part 1012 can set the portable information terminal 1 to the transmitting state and allow use of the function of the transmission buttons.

There is a fear that an erroneous operation of the transmission button during reception causes wrong transmission. According to the above configuration, the function of the transmission buttons is masked when it is detected that the portable information terminal 1 is in the horizontally held state, so that wrong transmission due to an erroneous operation can be prevented. In the case of using the portable information terminal 1 in the horizontally held state so that voice is shared by a plurality of persons, there is a case of capturing and transmitting voices of a plurality of persons as in a conference. Therefore, it is also possible to configure so that the masking operation in the horizontally held state described above can be stopped or canceled.

It should be noted that, in a case where voice is shared by a plurality of persons, a different operation from that in the vertically held state is required in a scene of operation such as capturing and transmitting voices of a plurality of persons as in a conference. Therefore, the portable information terminal 1 may be provided with another transmission button that is suitable for the above operation, different from the transmission buttons used in the vertically held state. Alternatively, the portable information terminal 1 may be provided with an external transmission button connected via wired or wireless connection. Moreover, by using the function of masking the transmission buttons described above, it is possible to configure so as to select and operate different transmission buttons between in the horizontally held state and in the vertically held state. Such a configuration provides transmission buttons suitable for the horizontally held state and the vertically held state, respectively, so that the convenience increases.

Further, when detecting that the portable information terminal 1 is in the horizontally held state, the function control part 1012 estimates that the portable information terminal 1 is in a receive-only state, and masks the VOX function 17. On the other hand, when detecting that the portable information terminal 1 is in the vertically held state, the function control part 1012 estimates that the portable information terminal 1 is in a ready-to-transmit state, and sets the VOX function 17 to an available state. That is, when detecting shift from the horizontally held state to the vertically held state, the function control part 1012 cancels the masking of the VOX function 17 and allows use of the VOX function. Moreover, when detecting shift from the vertically held state to the horizontally held state, the function control part 1012 masks the VOX function 17. Such a configuration can prevent that, during reception in the horizontally held state, the VOX function 17 erroneously functions and switches to the transmitting state because of ambient noise or the like. As a result, the quality of communication increases.

The function control part 1012 executes control depending on “vertically held” or “horizontally held” in the “held with the back side up” state as described above, for example. In other words, in the case of the “held with the back side up” and “vertically held” state, the function control part 1012 starts a function (the microphone 12 and the like) expected to be used when the portable information terminal 1 is directed in the substantially perpendicular direction to the ground, and stops a function (the loudspeaker 10 and the like) not expected to be used. On the other hand, in the state of the “held with the back side up” and “horizontally held” state, the function control part 1012 starts a function (the loudspeaker 10 and the like) expected to be used when the portable information terminal 1 is directed in the substantially horizontal direction to the ground, and also stops a function (the microphone 12 and the like) not expected to be used. The function control part 1012 may be configured to execute only one of the controls described above, or may be configured to execute some of the controls in combination. The function control part 1012 may be configured to be able to select the control to execute depending on “vertically held” or “horizontally held.”

As described above, the function control part 1012 executes predetermined control on the respective functions included by the portable information terminal 1, in accordance with four cases; a case where posture information is “held with the front side up” and “horizontally held,” a case where posture information is “held with the front side up” and “vertically held,” a case where posture information is “held with the back side up” and “horizontally held,” and a case where posture information is “held with the back side up” and “vertically held.”

The above is a more detailed description of the respective components of the portable information terminal 1.

Subsequently, an example of a flow when the portable information terminal 1 controls the function as the smartphone and the function as the transceiver will be described with reference to FIGS. 9 and 10.

Referring to FIG. 9, the posture information detection part 1011 acquires posture information of the portable information terminal 1, based on information from the position/rotation sensor 201 and the gyroscope 203 (step S001). For example, the posture information detection part 1011 acquires either “held with the front side up” or “held with the back side up” as posture information. Moreover, the posture information detection part 1011 acquires either “vertically held” or “horizontally held” as posture information. Then, the posture information detection part 1011 transmits the acquired posture information to the function control part 1012.

The function control part 1012 controls the function as the smartphone and the function as the transceiver of the portable information terminal 1 based on the posture information received from the posture information detection part 1011 (step S002).

Subsequently, with reference to FIG. 10, the processing at step S002 of FIG. 9 will be described in more detail.

Referring to FIG. 10, the function control part 1012 determines whether the portable information terminal 1 is in the “held with the front side up” state or in the “held with the back side up” state based on the posture information received from the posture information detection part 1011 (step S101).

When the portable information terminal 1 is “held with the front side up” (step S101, held with front side up), the function control part 1012 determines whether the portable information terminal 1 is in the “vertically held” state or in the “horizontally held” state based on the posture information received from the posture information detection part 1011 (step S102).

Then, when the portable information terminal 1 is in the “vertically held” state (step S102, vertically held), the function control part 1012 executes control for a case where the posture information is “held with the front side up” and “vertically held” (step S103). For example, the function control part 1012 stops the function as the transceiver. Moreover, for example, the function control part 1012 lowers the luminance of the display 41, turns off image display of the display 41, starts the camera 15, and powers off the touch panel 42. On the other hand, when the portable information terminal 1 is in the “horizontally held” state (step S102, horizontally held), the function control part 1012 executes control for a case where the posture information is “held with the front side up” and “horizontally held” (step S104).

For example, the function control part 1012 stops the function as the transceiver. Moreover, for example, the function control part 1012 raises the luminance of the display 41, causes the display 41 to display an image, stops the camera 15, and powers on the touchscreen 42.

On the other hand, when the portable information terminal 1 is in the “held with the back side up” state (step S101, held with back side up), the function control part 1012 determines whether the portable information terminal 1 is in the “vertically held” state or in the “horizontally held” state based on the posture information received from the posture information detection part 1011 (step S105).

Then, when the portable information terminal 1 is in the “vertically held” state (step

S105, vertically held), the function control part 1012 executes control for a case where the posture information is “held with the back side up” and “vertically held” (step S106). For example, the function control part 1012 stops the function as the smartphone. Moreover, for example, the function control part 1012 stops voice from the loudspeaker 10 or decreases the sound volume, starts voice input from the microphone 12, sets the portable information terminal 1 to the transmitting state, cancels the masking of the transmission buttons (left transmission button 2, the right transmission button 3, the left auxiliary transmission button 8, and the right auxiliary transmission button 9), and allow use of the VOX function 17. On the other hand, when the portable information terminal 1 is in the “horizontally held” state (step 5106, horizontally held), the function control part 1012 executes control for a case where the posture information is “held with the back side up” and “horizontally held” (step S107). For example, the function control part 1012 stops the function as the smartphone. Moreover, for example, the function control part 1012 starts voice output from the loudspeaker 10 or increases the sound volume, stops voice input through the microphone 12, sets the portable information terminal 1 to the reception state, mask the transmission buttons (left transmission button 2, the right transmission button 3, the left auxiliary transmission button 8, and the right auxiliary transmission button 9), and masks the VOX function 17.

Thus, the portable information terminal 1 in this example embodiment has, on the front side, the configuration as the smartphone used at the time of using the function as the smartphone and has, on the back side, the configuration as the transceiver used at the time of using the function as the transceiver. Moreover, the portable information terminal 1 has the posture information detection part 1011 and the function control part 1012. With such a configuration, the function control part 1012 of the portable information terminal 1 can control the function as the smartphone and the function as the transceiver of the portable information terminal 1, based on posture information acquired by the posture information detection part 1011. As a result, it becomes possible to easily perform switching of the functions based on the posture of the portable information terminal 1. Consequently, it becomes possible to increase the operability of the portable information terminal 1. Moreover, according to the configuration described above, it becomes possible to easily and precisely perform switching between the function as the smartphone and the function as the transceiver of the portable information terminal 1, so that it becomes possible to suppress increase of power consumption and occurrence of radio wave interference due to execution of the dual functions.

Further, the posture information detection part 1011 in this example embodiment is configured to acquire information of “held with the front side up” and information of “held with the back side up” as the posture information. With such a configuration, it becomes possible to stop a configuration installed on a face supposed to be not in use and a function supposed to be not in use, so that it becomes possible to efficiently perform switching of the functions, and it also becomes possible to suppress increase of power consumption and occurrence of radio wave interference.

Further, the posture information detection part 1011 in this example embodiment is configured to acquire information of “vertically held” and information of “horizontally held” as posture information. With such a configuration, it becomes possible to execute control of a function supposed to be in use and a function supposed to be not in use at the time of “vertically held” or “horizontally held” based on the posture information. As a result, it becomes possible to perform efficient control, and it becomes also possible to suppress increase of power consumption.

In this example embodiment, a case where the posture information detection part 1011 acquires posture information of the portable information terminal 1 based on information from the position/rotation sensor 201 and the gyroscope 203 has been described. However, the posture information detection part 1011 may be configured to acquire posture information of the portable information terminal 1 based on information other than the information from the position/rotation sensor 201 and the gyroscope 203.

For example, the posture information detection part 1011 can be configured to acquire posture information of the portable information terminal 1 based on image information acquired by the camera 7 and the camera 15.

For example, it is possible to identify the following information from the image information acquired by the camera 7 and the camera 15:
whether a person's face is in the eyesight;
whether the person's face in the eyesight is moving in the direction of entering the center of the eyesight or in the direction of leaving the eyesight;
in a case where the person's face is in the eyesight, which sides the top and bottom are directed to with reference to the screen (for example, detect the upper side (head or forehead) and lower side (jaw) of the face); and
when a plurality of faces can be recognized in the eyesight, which sides the respective faces are directed with reference to the screen and relatively.

The posture information detection part 1011 can be configured to acquire posture information of the portable information terminal 1 based on the above information.

For example, when a person's face can be recognized based on image information, it is estimated that a person such as the operator of the portable information terminal 1 is present on the side of a face where the camera (the camera 7 or the camera 15) having acquired the recognized image information is installed. Therefore, the posture information detection part 1011 can acquire posture information of “held with the front side up” or “held with the back side up” based on the above information.

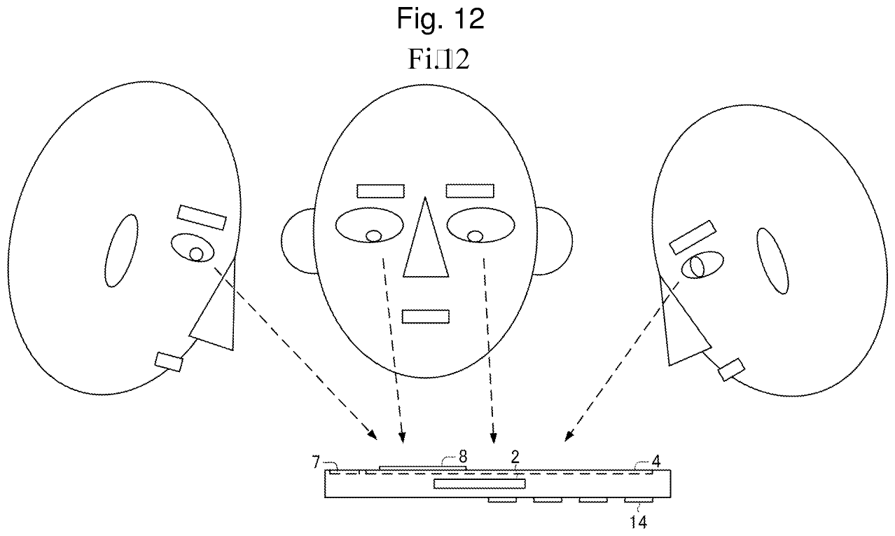

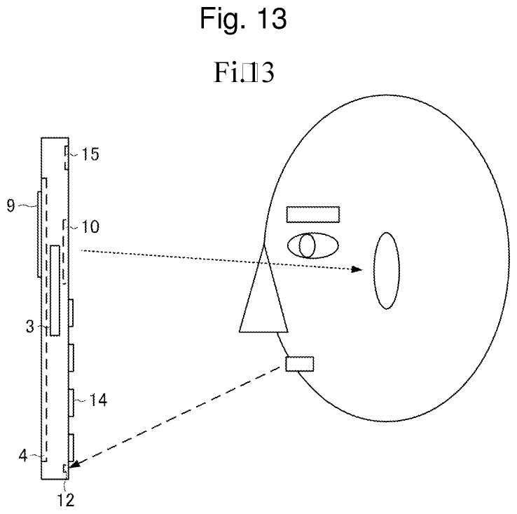

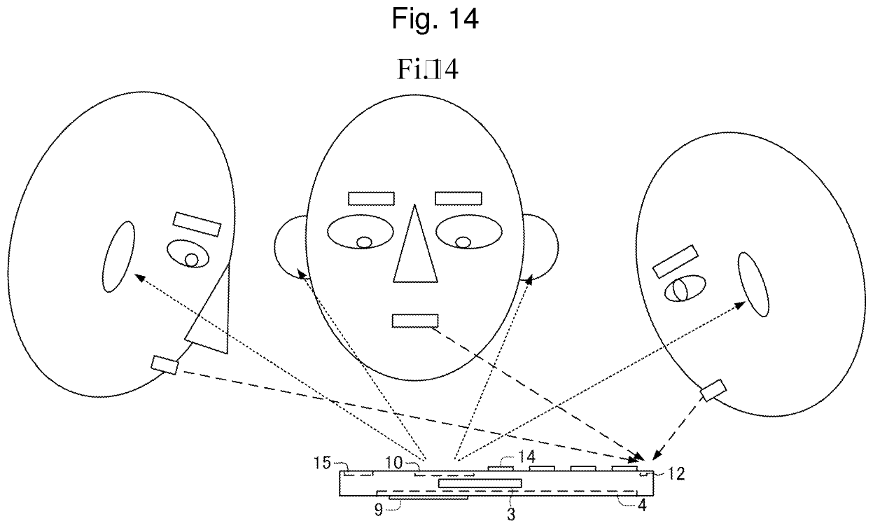

For example, in the case shown in FIGS. 11 and 12, a person's face can be recognized based on image information acquired by the camera 7. Then, the posture information detection part 1011 estimates that a function as a smartphone on a side having the camera 7 is mainly used, and acquires posture information of “held with the front side up.” On the other hand, in the case shown in FIGS. 13 and 14, a person's face can be recognized based on image information acquired by the camera 15. Then, the posture information detection part 1011 estimates that a function as a transceiver on a side having the camera 15 is mainly used, and acquires posture information of “held with the back side up.”

Further, the posture information detection part 1011 can acquire posture information of “vertically held” or “horizontally held” depending on whether the person's face shown by the image information is seen so as to face the front or inclined as if it looks down.

For example, in the cases shown in FIGS. 11 and 13, a person's face recognized based on the image information acquired by the camera 7 or the camera 15 appears to face the front. In such a case, the posture information detection part 1011 estimates that the portable information terminal 1 and the operator of the portable information terminal 1 are in a parallel relation, and acquires posture information of “vertically held.” On the other hand, in the cases shown in FIGS. 12 and 14, a person's face recognized based on the image information acquired by the camera 7 or the camera 15 appears to be inclined as if it looks down. In such a case, the posture information detection part 1011 estimates that the portable information terminal 1 and the operator of the portable information terminal 1 are in the perpendicular relation, and acquires posture information of “horizontally held.”

Further, by capturing an operator's face as a moving image using the camera 7 or the camera 15 and continuously extracting the tilt state of the operator's face, it is possible to continuously acquire posture information.

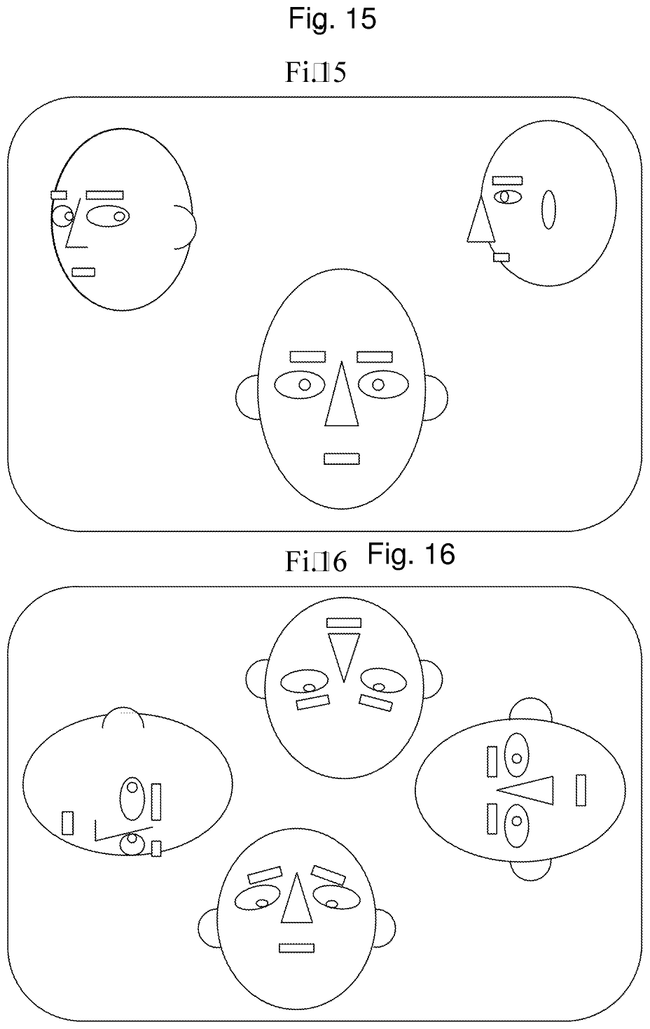

It can also be thought that faces of a plurality of persons can be recognized based on image information acquired by the camera 7 or the camera 15. In such a case, for example, as shown in FIG. 15, when the orientations of the tops and bottoms of the respective faces are aligned, it can be estimated that the portable information terminal 1 is in the “vertically held” state. Therefore, the posture information detection part 1011 acquires posture information of “vertically held.” On the other hand, as shown in FIG. 16, when the orientations of the tops and bottoms of a plurality of faces are not aligned, for example, when the orientations of the respective faces can be visually recognized so that the faces look into from the periphery of the eyesight and surround, it can be estimated that the portable information terminal 1 is in the “horizontally held” state. Therefore, the posture information detection part 1011 acquires posture information of “horizontally held.”

The camera 7 and the camera 15 may have a zoom function of optical type, electronic type or the like. When it is estimated that the portable information terminal 1 is horizontally held, the processor 101 can acquire wider ambient information by setting the zoom function to a wide angle.

As described above, the posture information detection part 1011 can be configured to acquire posture information of the portable information terminal 1 based on image information acquired by the camera 7 or the camera 15. The posture information detection part 1011 may be configured to acquire posture information in combination of image information acquired by the camera 7 and 15 and information from the position/rotation sensor 201 and the gyroscope 203.

Further, in this example embodiment, the portable information terminal 1 that has, on the front side, a configuration as a smartphone and has, on the back side, a configuration as a transceiver has been described. However, control based on posture information described in this example embodiment can also be applied to a portable information terminal other than the portable information terminal 1. For example, control based on posture information described in this example embodiment can also be applied to a portable information terminal which has only a configuration as a smartphone or a portable information terminal which has only a configuration as a transceiver.

For example, it is assumed that there is a portable information terminal which has, on the front side, the configuration as the smartphone as shown in FIG. 1 and does not have, on the back side, the configuration as the transceiver (for example, only the camera 15 in FIG. 2 is installed).

In such a case, it can be estimated that when the front side of the portable information terminal faces the operator, that is, the portable information terminal is held with the front side up, the operator may perform input/output operation. On the other hand, it can be estimated that when the back side of the portable information terminal faces the operator, that is, the portable information terminal is held with the back side up, the operator will not perform input operation or the operator shows the portable information terminal that the operator does not intend to perform input operation. Then, it is thought to execute the following control based on the estimation result.

When it is estimated that the portable information terminal is held with the front side up, the display 41, the camera 7, the camera 15, and the touch sensor 42 of the touchscreen 4 perform operation in the smartphone mode.

When it is estimated that the portable information terminal is held with the back side up, it is estimated that the display 41 and the touch sensor 42 do not face the operator. Therefore, the function control part executes control so as to stop operation of the display 41 and the touch sensor 42 or suppress the capability as compared with when the portable information terminal is held with the front side up.

Further, the abovementioned control is executed depending on “held with the front side up” “vertically held” or “held with the front side up” “horizontally held.”

Further, for example, it is assumed that there is a portable information terminal which has, on the front side, the configuration as the transceiver as shown in FIG. 2 and does not have, on the back side, the configuration as the smartphone (for example, only the camera 7 in FIG. 1 is installed).

In such a case, it can be estimated that when the front side of the portable information terminal faces the operator, that is, the portable information terminal is held with the front side up, the operator may perform input/output operation. On the other hand, it can be estimated that when the back side of the portable information terminal faces the operator, that is, the portable information terminal is held with the back side up, the operator will not perform input operation or the operator shows the portable information terminal that the operator does not intend to perform input operation. Then, it is thought to execute the following control based on the estimation result.

When it is estimated that the portable information terminal is held with the front side up, the loudspeaker 10, the microphone 12, and the keys 14 perform operation in the transceiver mode.

When it is estimated that the portable information terminal is held with the back side up, it is estimated that the loudspeaker 10, the microphone 12, and the keys 14 do not face the operator. Therefore, the function control part controls so as to stop operation of the loudspeaker 10, the microphone 12, and the keys 14.

Further, the abovementioned control depending on the state of being “held with the back side up” “vertically held” or the state of being “held with the back side up” “horizontally held” is executed when the portable information terminal is “held with the front side up” “vertically held” or “held with the front side up” “horizontally held.”

Thus, control based on posture information described in this example embodiment may be applied to a portable information terminal other than the portable information terminal 1.

### Second Example Embodiment

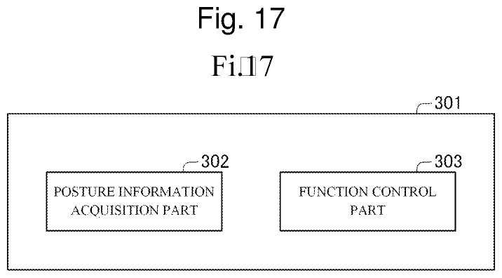

Next, a second example embodiment of the present invention will be described with reference to FIG. 17. In the second example embodiment, the outline of the configuration of a portable information terminal 301 will be described. In this example embodiment, the outline of the configuration of the portable information terminal 301 will be described.

The portable information terminal 301 in this example embodiment has: a configuration as a smartphone that is used at the time of using a function as a smartphone and installed on a predetermined face of a case of the portable information terminal 301; and a configuration as a transceiver that is used at the time of using a function as a transceiver and installed on a face located on the opposite side of the case from the face on which the configuration as the smartphone is installed.

Further, referring to FIG. 17, the portable information terminal 301 includes a posture information acquisition part 302, and a function control part 303. For example, the portable information terminal 301 has a storage unit and an arithmetic and logic unit that are not shown in the drawings. By execution of a program stored in the storage unit by the arithmetic and logic unit, the posture information acquisition part 302 and the function control part 303 are realized.

The posture information acquisition part 302 acquires posture information showing the posture of the portable information terminal 301. Then, the function control part 303 controls the function as the smartphone and the function as the transceiver based on the posture information acquired by the posture information acquisition part 302.

Thus, the portable information terminal 301 in this example embodiment has the configuration as the smartphone that is used at the time of using the function as the smartphone and installed on a predetermined face of a case of the portable information terminal 301; the configuration as the transceiver that is used at the time of using the function as the transceiver and associated with the face located on the opposite side of the case from the face associated with the configuration as the smartphone. Moreover, the portable information terminal 301 has the posture information acquisition part 302 and the function control part 303. With such a configuration, the function control part 303 of the portable information terminal 301 can control the function as the smartphone and the function as the transceiver included by the portable information terminal 301 based on the posture information acquired by the posture information acquisition part 302. As a result, it becomes possible to control the function as the smartphone and the function as the transceiver based on the posture of the portable information terminal 301, and it becomes possible to easily switch the functions. Consequently, it becomes possible to increase the operability of the portable information terminal 301. Moreover, according to the configuration described above, it becomes possible to easily perform switching between the function as the smartphone and the function as the transceiver included by the portable information terminal 301, so that it becomes possible to surpress increase of power consumption and occurrence of radio wave interference due to execution of dual functions.

Further, the portable information terminal 301 described above can be realized by installing a predetermined program in the portable information terminal 301 itself. To be specific, a computer program as another aspect of the present invention is a computer program including instructions for causing the portable information terminal 301 to perform operations.

The portable information terminal 301 includes a configuration as a smartphone that is used at a time of using a function as a smartphone and associated with a predetermined face of a case of the portable information terminal 301, and a configuration as a transceiver that is used at a time of using a function as a transceiver and associated with a face located on an opposite side of the case from the face associated with the configuration as the smartphone. The operations include: acquiring posture information showing a posture of the portable information terminal 301; and controlling the function as the smartphone and the function as the transceiver based on the acquired posture information.

Further, the portable information terminal controlling method executed by the portable information terminal 301 described above is a portable information terminal controlling method executed by the portable information terminal 301 which includes a configuration as a smartphone that is used at a time of using a function as a smartphone and associated with a predetermined face of a case of the portable information terminal 301, and a configuration as a transceiver that is used at a time of using a function as a transceiver and associated with a face located on an opposite side of the case from the face associated with the configuration as the smartphone. The portable information terminal controlling method includes: acquiring posture information showing the posture of the portable information terminal 301; and controlling the function as the smartphone and the function as the transceiver based on the acquired posture information.

The inventions of the program and the portable information terminal controlling method having the configurations described above also have the same effects as the portable information terminal 301, and therefore, can achieve the object of the present invention.

### Supplementary Notes

The whole or part of the example embodiments disclosed above can be described as the following supplementary notes. The overview of a portable information terminal according to the present invention will be described below. However, the present invention is not limited to the following configurations.

### Supplementary Note 1

A portable information terminal comprising:

a configuration as a smartphone that is used at a time of using a function as a smartphone and associated with a predetermined face of a case of the portable information terminal;

a configuration as a transceiver that is used at a time of using a function as a transceiver and associated with a face located on an opposite side of the case from the face associated with the configuration as the smartphone;

a posture information acquisition part configured to acquire posture information showing a posture of the portable information terminal; and

a function control part configured to control the function as the smartphone and the function as the transceiver based on the posture information acquired by the posture information acquisition part.

### Supplementary Note 2

The portable information terminal according to Supplementary Note 1, wherein:

the posture information acquisition part is configured to acquire first posture information and second posture information as the posture information, the first posture information showing that an operator of the portable information terminal is on a side of the face having the configuration as the smartphone, the second posture information showing that

the operator of the portable information terminal is on a side of the face having the configuration as the transceiver; and

the function control part is configured to control the function as the smartphone and the function as the transceiver based on the first posture information and the second posture information acquired by the posture information acquisition part.

### Supplementary Note 3

The portable information terminal according to Supplementary Note 1 or 2, wherein:

the posture information acquisition part is configured to acquire first posture information and second posture information as the posture information, the first posture information showing a state where the face associated with the configuration as the smartphone is oriented substantially upward, the second posture information showing a state where the face associated with the configuration as the transceiver is oriented substantially upward; and

the function control part is configured to control the function as the smartphone and the function as the transceiver based on the first posture information and the second posture information acquired by the posture information acquisition part.

### Supplementary Note 4

The portable information terminal according to Supplementary Note 2 or 3, wherein the function control part is configured to restrict the function as the transceiver when the posture information acquisition part acquires the first posture information, and restrict the function as the smartphone when the posture information acquisition part acquires the second posture information.

### Supplementary Note 5

The portable information terminal according to any of Supplementary Notes 1 to 4, wherein:

a touchscreen is included as the configuration as the smartphone, and a loudspeaker is included as the configuration as the transceiver; and

the function control part is configured to stop operation of the loudspeaker when the posture information acquisition part acquires the first posture information, and stop operation of the touchscreen when the posture information acquisition part acquires the second posture information.

### Supplementary Note 6

The portable information terminal according to any of Supplementary Notes 2 to 5, wherein:

the portable information terminal includes cameras on the face having the configuration as the smartphone and the face having the configuration as the transceiver; and

the posture information acquisition part is configured to acquire the first posture information and the second posture information based on image information acquired by the cameras included by the portable information terminal.

### Supplementary Note 7

The portable information terminal according to any of Supplementary Notes 1 to 6, wherein:

the posture information acquisition part is configured to acquire third posture information and fourth posture information, the third posture information showing that the portable information terminal is oriented in a direction substantially perpendicular to ground, the fourth posture information showing that the portable information terminal is oriented in a direction substantially horizontal to the ground; and

the function control part is configured to control the function as the smartphone and the function as the transceiver based on the third posture information and the fourth posture information acquired by the posture information acquisition part.

### Supplementary Note 8

The portable information terminal according to Supplementary Note 7, wherein the function control part is configured to, when the posture information acquisition part acquires the third posture information, start a function supposed to be used in a case where the portable information terminal is oriented in the direction substantially perpendicular to the ground and also stop a function not supposed to be used and, when the posture information acquisition part acquires the fourth posture information, start a function supposed to be used in a case where the portable information terminal is oriented in the direction substantially horizontal to the ground and also stop a function not supposed to be used.

### Supplementary Note 9

The portable information terminal according to Supplementary Note 7 or 8, wherein:

the portable information terminal includes cameras on the face having the configuration as the smartphone and the face having the configuration as the transceiver; and

the posture information acquisition part is configured to acquire the third posture information and the fourth posture information based on image information acquired by the cameras included by the portable information terminal.

### Supplementary Note 10

A portable information terminal controlling method executed by a portable information terminal which includes a configuration as a smartphone that is used at a time of using a function as a smartphone and associated with a predetermined face of a case of the portable information terminal, and a configuration as a transceiver that is used at a time of using a function as a transceiver and associated with a face located on an opposite side of the case from the face associated with the configuration as the smartphone, the portable information terminal controlling method comprising:

acquiring posture information showing a posture of the portable information terminal; and

controlling the function as the smartphone and the function as the transceiver based on the acquired posture information.

### Supplementary Note 11

The portable information terminal controlling method according to Supplementary Note 10, comprising:

acquiring first posture information and second posture information as the posture information, the first posture information showing that an operator of the portable information terminal is on a side of the face having the configuration as the smartphone, the second posture information showing that the operator of the portable information terminal is on a side of the face having the configuration as the transceiver; and

controlling the function as the smartphone and the function as the transceiver based on the first posture information and the second posture information acquired by the posture information acquisition part.

### Supplementary Note 12

The portable information terminal controlling method according to Supplementary Note 10 or 11, comprising:

acquiring first posture information and second posture information as the posture information, the first posture information showing a state where the face associated with the configuration as the smartphone is oriented substantially upward, the second posture information showing a state where the face associated with the configuration as the transceiver is oriented substantially upward; and

controlling the function as the smartphone and the function as the transceiver based on the first posture information and the second posture information acquired by the posture information acquisition part.

### Supplementary Note 13

The portable information terminal controlling method according to Supplementary Note 11 or 12, comprising restricting the function as the transceiver when the posture information acquisition part acquires the first posture information, and restricting the function as the smartphone when the posture information acquisition part acquires the second posture information.

### Supplementary Note 14

The portable information terminal controlling method according to any of Supplementary Notes 10 to 13, wherein:

a touchscreen is included as the configuration as the smartphone, and a loudspeaker is included as the configuration as the transceiver; and operation of the loudspeaker is stopped when the posture information acquisition part acquires the first posture information, and operation of the touchscreen is stopped when the posture information acquisition part acquires the second posture information.

### Supplementary Note 15

The portable information terminal controlling method according to any of Supplementary Notes 11 to 14, wherein:

the portable information terminal includes cameras on the face having the configuration as the smartphone and the face having the configuration as the transceiver; and

the first posture information and the second posture information are acquired based on image information acquired by the cameras included by the portable information terminal.

### Supplementary Note 16

A computer program comprising instructions for causing a portable information terminal to realize a posture information acquisition part and a function control part, the portable information terminal including a configuration as a smartphone that is used at a time of using a function as a smartphone and associated with a predetermined face of a case of the portable information terminal, and a configuration as a transceiver that is used at a time of using a function as a transceiver and associated with a face located on an opposite side of the case from the face associated with the configuration as the smartphone,

the posture information acquisition part being configured to acquire posture information showing a posture of the portable information terminal,

the function control part being configured to control the function as the smartphone and the function as the transceiver based on the acquired posture information.

### Supplementary Note 17

The computer program according to Supplementary Note 16, wherein:

the posture information acquisition part is configured to acquire first posture information and second posture information as the posture information, the first posture information showing that an operator of the portable information terminal is on a side of the face having the configuration as the smartphone, the second posture information showing that the operator of the portable information terminal is on a side of the face having the configuration as the transceiver; and

the function control part is configured to control the function as the smartphone and the function as the transceiver based on the first posture information and the second posture information acquired by the posture information acquisition part.

### Supplementary Note 18

The computer program according to Supplementary Note 16 or 17, wherein:

the posture information acquisition part is configured to acquire first posture information and second posture information as the posture information, the first posture information showing a state where the face associated with the configuration as the smartphone is oriented substantially upward, the second posture information showing a state where the face associated with the configuration as the transceiver is oriented substantially upward; and

the function control part is configured to control the function as the smartphone and the function as the transceiver based on the first posture information and the second posture information acquired by the posture information acquisition part.

### Supplementary Note 19

The computer program according to Supplementary Note 17 or 18, wherein the function control part is configured to restrict the function as the transceiver when the posture information acquisition part acquires the first posture information, and restrict the function as the smartphone when the posture information acquisition part acquires the second posture information.

### Supplementary Note 20

The computer program according to any of Supplementary Notes 16 to 20, wherein:

a touchscreen is included as the configuration as the smartphone, and a loudspeaker is included as the configuration as the transceiver; and

the function control part is configured to stop operation of the loudspeaker when the posture information acquisition part acquires the first posture information, and stop operation of the touchscreen when the posture information acquisition part acquires the second posture information.

### Supplementary Note 21

The computer program according to any of Supplementary Notes 17 to 20, wherein:

the portable information terminal includes cameras on the face having the configuration as the smartphone and the face having the configuration as the transceiver; and

the posture information acquisition part is configured to acquire the first posture information and the second posture information based on image information acquired by the cameras included by the portable information terminal.

The program described in the example embodiments and supplementary notes is stored in a storage device or recorded on a computer-readable recording medium. For example, the recording medium is a portable medium such as a flexible disk, an optical disk, a magneto-optical disk, and a semiconductor memory.

Although the present invention has been described above with reference to the example embodiments, the present invention is not limited to the example embodiments. The configurations and details of the present invention can be changed in various manner that can be understood by one skilled in the art within the scope of the present invention.

The present invention is based upon and claims the benefit of priority from Japanese patent application No. 2017-006804, filed on Jan. 18, 2017, the disclosure of which is incorporated herein in its entirety by reference.

### DESCRIPTION OF NUMERALS

1 portable information terminal
2 left transmission button
3 right transmission button
4 touchscreen
41 display
42 touch sensor
5 reception speaker
6 microphone
7 camera
8 left auxiliary transmission button
9 right auxiliary transmission button
10 loudspeaker
11 reception speaker
12 microphone
13 auxiliary display
14 keys
15 camera
16 transmission/reception identification display
17 VOX function
101 processor
1011 posture information detection part
1012 function control part
102 memory
103 program
104 application data
105 setup parameter
106 storage device
201 position/rotation sensor
202 acceleration sensor
203 gyroscope
211 timer
221 communication system
301 portable information terminal
302 posture information acquisition part
303 function control part

1. A portable information terminal comprising:
a configuration as a smartphone that is used at a time of using a function as a smartphone and associated with a predetermined face of a case of the portable information terminal;
a configuration as a transceiver that is used at a time of using a function as a transceiver and associated with a face located on an opposite side of the case from the face associated with the configuration as the smartphone;
a posture information acquisition part configured to acquire posture information showing a posture of the portable information terminal; and
a function control part configured to control the function as the smartphone and the function as the transceiver based on the posture information acquired by the posture information acquisition part.

2. The portable information terminal according to claim 1, wherein:
the posture information acquisition part is configured to acquire first posture information and second posture information as the posture information, the first posture information showing that an operator of the portable information terminal is on a side of the face having the configuration as the smartphone, the second posture information showing that the operator of the portable information terminal is on a side of the face having the configuration as the transceiver; and
the function control part is configured to control the function as the smartphone and the function as the transceiver based on the first posture information and the second posture information acquired by the posture information acquisition part.

3. The portable information terminal according to claim 1, wherein:
the posture information acquisition part is configured to acquire first posture information and second posture information as the posture information, the first posture information showing a state where the face associated with the configuration as the smartphone is oriented substantially upward, the second posture information showing a state where the face associated with the configuration as the transceiver is oriented substantially upward; and
the function control part is configured to control the function as the smartphone and the function as the transceiver based on the first posture information and the second posture information acquired by the posture information acquisition part.

4. The portable information terminal according to claim 2, wherein the function control part is configured to restrict the function as the transceiver when the posture information acquisition part acquires the first posture information, and restrict the function as the smartphone when the posture information acquisition part acquires the second posture information.

5. The portable information terminal according to claim 1, wherein:
a touchscreen is included as the configuration as the smartphone, and a loudspeaker is included as the configuration as the transceiver; and
the function control part is configured to stop operation of the loudspeaker when the posture information acquisition part acquires the first posture information, and stop operation of the touchscreen when the posture information acquisition part acquires the second posture information.

6. The portable information terminal according to claim 2, wherein:
the portable information terminal includes cameras on the face having the configuration as the smartphone and the face having the configuration as the transceiver; and
the posture information acquisition part is configured to acquire the first posture information and the second posture information based on image information acquired by the cameras included by the portable information terminal.

7. The portable information terminal according to claim 1, wherein:
the posture information acquisition part is configured to acquire third posture information and fourth posture information, the third posture information showing that the portable information terminal is oriented in a direction substantially perpendicular to ground, the fourth posture information showing that the portable information terminal is oriented in a direction substantially horizontal to the ground; and
the function control part is configured to control the function as the smartphone and the function as the transceiver based on the third posture information and the fourth posture information acquired by the posture information acquisition part.

8. The portable information terminal according to claim 7, wherein the function control part is configured to, when the posture information acquisition part acquires the third posture information, start a function supposed to be used in a case where the portable information terminal is oriented in the direction substantially perpendicular to the ground and also stop a function not supposed to be used and, when the posture information acquisition part acquires the fourth posture information, start a function supposed to be used in a case where the portable information terminal is oriented in the direction substantially horizontal to the ground and also stop a function not supposed to be used.

9. The portable information terminal according to claim 7, wherein:
the portable information terminal includes cameras on the face having the configuration as the smartphone and the face having the configuration as the transceiver; and
the posture information acquisition part is configured to acquire the third posture information and the fourth posture information based on image information acquired by the cameras included by the portable information terminal.

10. A portable information terminal controlling method executed by a portable information terminal which includes a configuration as a smartphone that is used at a time of using a function as a smartphone and associated with a predetermined face of a case of the portable information terminal, and a configuration as a transceiver that is used at a time of using a function as a transceiver and associated with a face located on an opposite side of the case from the face associated with the configuration as the smartphone, the portable information terminal controlling method comprising:
acquiring posture information showing a posture of the portable information terminal; and
controlling the function as the smartphone and the function as the transceiver based on the acquired posture information.

11. A non-transitory computer-readable medium for storing a computer program comprising instructions for causing a portable information terminal to perform operations, the portable information terminal including a configuration as a smartphone that is used at a time of using a function as a smartphone and associated with a predetermined face of a case of the portable information terminal, and a configuration as a transceiver that is used at a time of using a function as a transceiver and associated with a face located on an opposite side of the case from the face associated with the configuration as the smartphone, the operations including:
acquiring posture information showing a posture of the portable information terminal; and
controlling the function as the smartphone and the function as the transceiver based on the acquired posture information.
